(19) United States
(12) Patent Application Publication
(10) Pub. No.: US 2022/0152791 A1
(43) Pub. Date: May 19, 2022

(54) SCREW TIGHTENING ANGLE CONVERSION HEAD

(71) Applicant: Dacheng Zhou, Meihekou (CN)

(72) Inventor: Dacheng Zhou, Meihekou (CN)

(21) Appl. No.: 17/528,163

(22) Filed: Nov. 16, 2021

(30) Foreign Application Priority Data
Nov. 17, 2020 (CN) 202022767193.7

(51) Int. Cl. B25B 17/00; B25B 15/02; B25B 15/00

(52) U.S. Cl. CPC B25B 17/00; B25B 23/005; B25B 15/004; B25B 15/02

(57) ABSTRACT

Disclosed a screw tightening angle conversion head, including a conversion head body, wherein one end of which is fixedly provided with a mounting groove, a fixed cover plate is fixedly arranged at the upper end of the mounting groove, a transmission worm is rotatably arranged at one end inside the conversion head body close to the mounting groove, one end of the transmission worm penetrates through the conversion head body and extends out from an outer end, a rotating seat is fixedly arranged at a rotational junction between the transmission worm and the inside of the conversion head body, annular worm teeth are fixedly arranged at the outer side of the transmission worm, a rotating shaft is rotatably arranged at one end inside the conversion head body away from the transmission worm, and the outer wall of the rotating shaft is fixedly connected with an intermediate gear.

### CROSS REFERENCE TO RELATED APPLICATIONS

The present application claims the benefit of Chinese Patent Application No. 202022767193.7 filed on Nov. 17, 2020, the contents of which are incorporated herein by reference in their entirety.

### TECHNICAL FIELD

The application relates to the technical field of auxiliary screw tightening devices, in particular to a screw tightening angle conversion head.

### BACKGROUND ART

In daily life, we often need to use screws to connect and fix articles, when using the screws, we need to tighten the screws, and in order to tighten the screws, we need to use auxiliary screw tightening tools, so that the screws can be tightened easily, which is conducive to connecting and fixing the articles.

A traditional screw tightening tool is to clamp the screw, and then rotate the tool to tighten the screw, when tightening the screw in a 90° direction, an ordinary tool can only move up and down in the horizontal direction, such that the tool requires a certain movement space to tighten the screw, but for a place where the movement space is relatively small, there is insufficient movement space for the ordinary tool, so it is difficult to tighten the screw, thereby being very inconvenient to use.

### SUMMARY OF THE APPLICATION

The purpose of the present application is to solve the shortcomings in the prior art, and proposes a screw tightening angle conversion head.

In order to achieve the above purpose, the present application adopts the following technical solution: a screw tightening angle conversion head, including a conversion head body, wherein a mounting groove is fixedly formed in one end of the conversion head body, a fixed cover plate is fixedly arranged at the upper end of the mounting groove, a transmission worm is rotatably arranged at one end inside the conversion head body close to the mounting groove, one end of the transmission worm penetrates through the conversion head body and extends out from an outer end, a rotating seat is fixedly arranged at a rotational junction between the transmission worm and the inside of the conversion head body, annular worm teeth are fixedly arranged at the outer side of the transmission worm, a rotating shaft is rotatably arranged at one end inside the conversion head body away from the transmission worm, the outer wall of the rotating shaft is fixedly connected with an intermediate gear, the intermediate gear is engaged with the transmission worm, both ends of the rotating shaft are fixedly connected with mounting seats, and rotating chucks I or rotating chucks II are fixedly arranged at the upper ends of the two mounting seats.

As a further description of the above technical solution:

The fixed cover plate is fixedly connected with the conversion head body through four fastening bolts.

As a further description of the above technical solution:

A square rotating rod is fixedly formed in the end part of one end of the transmission worm extending out from the conversion head body.

As a further description of the above technical solution:

The transmission worm is fastened inside the conversion head body through the fixed cover plate.

As a further description of the above technical solution: Cover plates are fixedly sleeved on the outer sides of the two mounting seats.

As a further description of the above technical solution:

A slot in the middle of the rotating chuck I or the rotating chuck II can be set in various shapes to adapt to crews with different heads.

As a further description of the above technical solution:

The square rotating rod at the end part of the transmission worm can also be arranged in a hexagonal shape or other shapes.

As a further description of the above technical solution:

The intermediate gear is a concave surface gear.

As a further description of the above technical solution:

The conversion head body can convert the tool direction by 90°, and the same as the screwdriver rotation principle, the conversion head body cannot be used alone and needs to be used in conjunction with a universal tool.

The application has the following beneficial effects:

According to the screw tightening angle conversion head proposed by the present application, the tool position can be converted by 90° by using the conversion head, so that a screw tightening distance is the same as a screwdriver rotating distance, which is more suitable for places with relatively narrow movement spaces, the position of the tool can be changed to ensure a greater movement space for the tool, so that the screw can be tightened, which is more convenient to use.

According to the screw tightening angle conversion head proposed by the present application, by setting the transmission worm and the intermediate gear, the rotation in the vertical direction can be converted into the rotation in the horizontal direction, thereby changing the direction of rotation, and a gear with a greater diameter is driven by a worm with a smaller diameter, thereby being more labor-saving, making screw tightening easier and effectively reducing the physical loss of a user, and by setting the replaceable rotating chuck, screws with different heads can be tightened, such that the screw tightening angle conversion head is wider in use application, is more convenient to use, and is worthy of promotion.

### BRIEF DESCRIPTION OF THE DRAWINGS

FIG. 1 is a front view of a screw tightening angle conversion head proposed by the present application;

FIG. 2 is a front cross-sectional view of a screw tightening angle conversion head proposed by the present application;

FIG. 3 is a schematic structural diagram of a transmission worm of a screw tightening angle conversion head proposed by the present application;

FIG. 4 is a top view of a screw tightening angle conversion head proposed by the present application; and

FIG. 5 is a top cross-sectional view of a screw tightening angle conversion head proposed by the present application.

Illustration on figures:

1. conversion head body; 2. transmission worm; 3. fixed cover plate; 4. fastening bolt; 5. rotating chuck I; 6. rotating chuck II; 7. mounting groove; 8. rotating seat; 9. intermediate gear; 10. rotating shaft; 11. annular worm tooth; 12. square rotating rod; 13. cover plate; 14. mounting seat.

### DETAILED DESCRIPTION OF THE EMBODIMENTS

A clear and complete description of technical solutions in the embodiments of the present application will be given below, in combination with the drawings in the embodiments of the present application. Apparently, the embodiments described below are merely a part, but not all, of the embodiments of the present application. All of other embodiments, obtained by those of ordinary skill in the art based on the embodiments of the present application without any creative effort, fall into the protection scope of the present application.

In the descriptions of the present application, it should be noted that the orientation or positional relationships indicated by terms such as “center”, “upper”, “lower”, “left”, “right”, “vertical”, “horizontal”, “inner” and “outer” are orientation or positional relationships shown in the drawings, and are only for the convenience of describing the present application and simplifying the description, rather than indicating or implying that devices or elements referred to must have specific orientations, be constructed and operated in specific orientations, and therefore cannot be understood as limitations of the present application; and the terms “first” and “second” and “third” are only used for descriptive purposes, but cannot be understood as indicating or implying relative importance. In addition, unless expressly stipulated and limited otherwise, the terms “installed”, “connected” and “connection” should be interpreted in a broad sense, for example, it can be a fixed connection, or a detachable connection, or an integral connection; it can be a mechanical connection or an electrical connection; and it can be directly connected or indirectly connected through an intermediate medium, and it can be internal communication of two elements. For those of ordinary skill in the art, the specific meanings of the above-mentioned terms in the present application can be understood under specific circumstances.

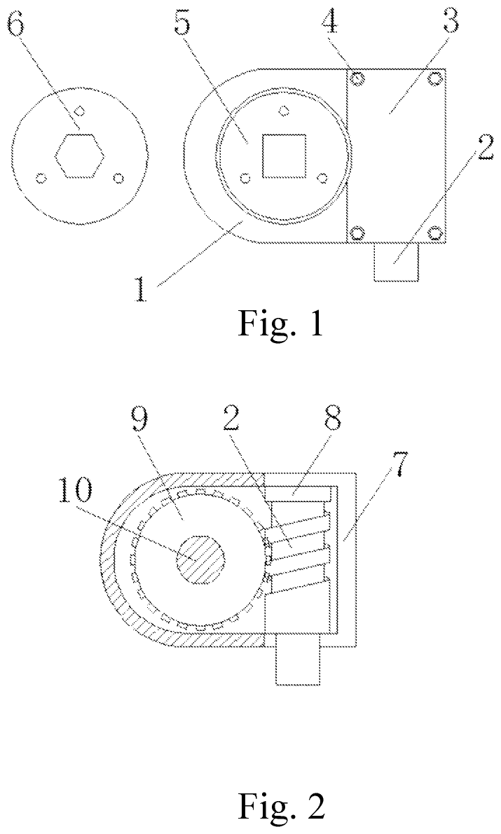

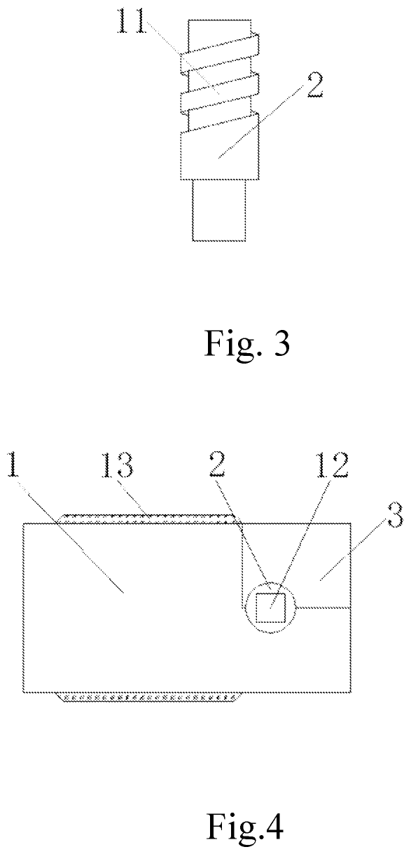

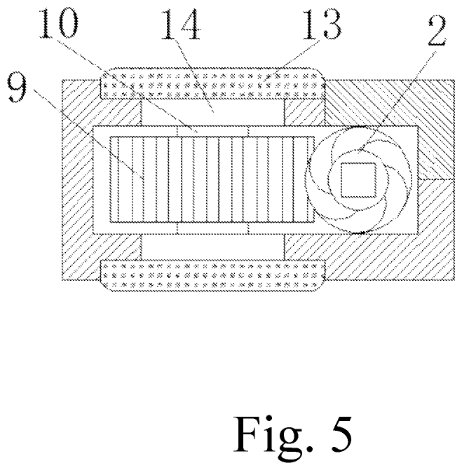

Referring to FIGS. 1-5, the present application provides an embodiment: a screw tightening angle conversion head, including a conversion head body 1, wherein a mounting groove 7 is fixedly formed in one end of the conversion head body 1, a fixed cover plate 3 is fixedly arranged at the upper end of the mounting groove 7, a transmission worm 2 is rotatably arranged at one end inside the conversion head body 1 close to the mounting groove 7, one end of the transmission worm 2 penetrates through the conversion head body 1 and extends out from an outer end, a rotating seat 8 is fixedly arranged at a rotational junction between the transmission worm 2 and the inside of the conversion head body 1, annular worm teeth 11 are fixedly arranged at the outer side of the transmission worm 2, a rotating shaft 10 is rotatably arranged at one end inside the conversion head body 1 away from the transmission worm 2, the outer wall of the rotating shaft 10 is fixedly connected with an intermediate gear 9, the intermediate gear 9 is engaged with the transmission worm 2, both ends of the rotating shaft 10 are fixedly connected with mounting seats 14, and rotating chucks I 5 or rotating chucks II 6 are fixedly arranged at the upper ends of the two mounting seats 14.

The fixed cover plate 3 is fixedly connected with the conversion head body 1 through four fastening bolts 4, a square rotating rod 12 is fixedly formed in the end part of one end of the transmission worm 2 extending out from the conversion head body 1, the transmission worm 2 is fastened inside the conversion head body 1 through the fixed cover plate 3, cover plates 13 are fixedly sleeved on the outer sides of the two mounting seats 14, a slot in the middle of the rotating chuck I 5 or the rotating chuck II 6 can be set in various shapes to adapt to crews with different heads, the square rotating rod 12 at the end part of the transmission worm 2 can also be arranged in a hexagonal shape or other shapes, the intermediate gear 9 is a concave surface gear, the conversion head body 1 can convert the tool direction by 90°, and the same as the screwdriver rotation principle, the conversion head body 1 cannot be used alone and needs to be used in conjunction with a universal tool.

Working principle: when the screw tightening angle conversion head is used, the rotating chuck I 5 or the rotating chuck II 6 is fixedly installed at the upper end of the mounting seat 14 at first, then the conversion head body 1 is placed on the head of a screw that needs to be tightened, the rotating chuck is clamped on the head of the screw, then an external tool is clamped in the square rotating rod 12 at the end part of the transmission worm 2, the tool is rotated to drive the transmission worm 2 to rotate, the transmission worm 2 drives the intermediate gear 9 to rotate, the intermediate gear 9 drives the rotating shaft 10 to rotate, so as to drive the mounting seat 14 and the rotating chuck I 5 or the rotating chuck II 6 to rotate to tighten the screw, the intermediate gear 9 with a greater diameter is driven by the transmission worm 2 with a smaller diameter, thereby being more labor-saving, making the tightening of the screw easier and effectively reducing the physical loss of the user, and by setting the replaceable rotating chuck, screws with different heads can be tightened, such that the use application is wider.

Finally, it should be noted that: the above descriptions are only the preferred embodiments of the present application and are not intended to limit the present application. Although the present application has been described in detail with reference to the foregoing embodiments, for those skilled in the art, they can still make modifications to the technical solutions recorded in the foregoing embodiments, or make equivalent replacements on some of the technical features. Any modifications, equivalent replacements, improvements and the like, made within the spirit and principle of the present application, all should be included in the protection scope of the present application.

What is claimed is:

1. A screw tightening angle conversion head, comprising a conversion head body (1), wherein a mounting groove (7) is fixedly formed in one end of the conversion head body (1), a fixed cover plate (3) is fixedly arranged at the upper end of the mounting groove (7), a transmission worm (2) is rotatably arranged at one end inside the conversion head body (1) close to the mounting groove (7), one end of the transmission worm (2) penetrates through the conversion head body (1) and extends out from an outer end, a rotating seat (8) is fixedly arranged at a rotational junction between the transmission worm (2) and the inside of the conversion head body (1), annular worm teeth (11) are fixedly arranged at the outer side of the transmission worm (2), a rotating shaft (10) is rotatably arranged at one end inside the conversion head body (1) away from the transmission worm (2), the outer wall of the rotating shaft (10) is fixedly connected with an intermediate gear (9), the intermediate gear (9) is engaged with the transmission worm (2), both ends of the rotating shaft (10) are fixedly connected with mounting seats (14), and rotating chucks I (5) or rotating chucks II (6) are fixedly arranged at the upper ends of the two mounting seats (14).

2. The screw tightening angle conversion head according to claim 1, wherein the fixed cover plate (3) is fixedly connected with the conversion head body (1) through four fastening bolts (4).

3. The screw tightening angle conversion head according to claim 1, wherein a square rotating rod (12) is fixedly formed in the end part of one end of the transmission worm (2) extending out from the conversion head body (1).

4. The screw tightening angle conversion head according to claim 1, wherein the transmission worm (2) is fastened inside the conversion head body (1) through the fixed cover plate (3).

5. The screw tightening angle conversion head according to claim 1, wherein cover plates (13) are fixedly sleeved on the outer sides of the two mounting seats (14).

6. The screw tightening angle conversion head according to claim 1, wherein a slot in the middle of the rotating chuck I (5) or the rotating chuck II (6) can be set in various shapes to adapt to crews with different heads.

7. The screw tightening angle conversion head according to claim 1, wherein the square rotating rod (12) at the end part of the transmission worm (2) can also be arranged in a hexagonal shape or other shapes.

8. The screw tightening angle conversion head according to claim 1, wherein the intermediate gear (9) is a concave surface gear.

9. The screw tightening angle conversion head according to claim 1, wherein the conversion head body (1) can convert the tool direction by 90°, and the same as the screwdriver rotation principle, the conversion head body (1) cannot be used alone and needs to be used in conjunction with a universal tool.
